(19) United States
(12) Patent Application Publication
(10) Pub. No.: US 2008/0148913 A1
(43) Pub. Date: Jun. 26, 2008

(54) DISSECTING DEVICE AND METHOD FOR CELL AND TISSUE

(75) Inventors: Jan-Hao Chen, Changhua County (TW); Yeou-Bin Guu, Taichung City (TW); Yung-Feng Nien, Taichung City (TW); Wann-Hsin Chen, Hsinchu City (TW); Lih-Tao Hsu, Taoyuan County (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 11/693,656

(22) Filed: Mar. 29, 2007

(30) Foreign Application Priority Data
Dec. 21, 2006 (TW) TW95148157

(51) Int. Cl. G01N 1/06

(52) U.S. Cl. 83/23; 83/734

(57) ABSTRACT

A dissection device for organisms includes a table bearing an organism and at least one blade lifted or lowered to approach the table. The blade includes a connecting portion, a cutting portion having a curved edge, and a neck portion connecting the connecting portion and the cutting portion. When the blade is lowered to contact the table, the cutting portion is rotated with respect to the neck portion to have rolling contact with the table from a first point to a second point of the edge.

### BACKGROUND OF THE INVENTION

1. Field of the Invention

The invention relates to a device and a method of dissecting cells and tissues of an organism, and more particularly relates to a device and a method for dissecting cells and tissues by rolling contact.

2. Description of the Related Art

Operations on organisms, such as dissection and aspiration are frequently carried out in the field of biotechnology. Laser dissection techniques, such as laser capture micro-dissection (LCM), laser micro-dissection (LMD) and laser pressure catapulting (LPC) have become the main micro-dissection techniques for organisms. The three described laser dissection techniques can be conveniently applied to tiny spots but may have generate radioactive contaminants, have high-cost and are not applicable to humid environments.

U.S. Pat. No. 6,673,086 discloses a dissection device employing a needle continuously penetrating organisms for dissection. The dissecting speed of such a device is, however, low.

### BRIEF SUMMARY OF INVENTION

An embodiment of a dissection device for organisms of the invention comprises a table bearing an organism and at least one blade lifted or lowered to approach or depart from the table. The blade comprises a connecting portion, a cutting portion having a curved edge and a neck portion connecting the connecting portion and the cutting portion. When the blade is lowered to contact the table for cutting the organism, the cutting portion is rotated with respect to the neck portion to make rolling contact with the table from a first point to a second point of the edge.

Lines formed by connecting every point on the edge between the first point and the second point to the neck portion are not parallel to a moving direction of the lowered blade.

The invention further comprises a base lifted or lowered to approach the table. The connecting portion further comprises a through hole with which the base is engaged, thus, the base is connected to the connecting portion.

When the blade is lowered to contact the table, the table moves in a first direction, substantially parallel to the line formed by the first and second points to maintain rolling contact between the blade and the table.

When the blade is lowered to contact the table, the table moves in a first direction, substantially parallel to the line formed by the first and second points to maintain rolling contact between the blade and the table.

The cutting portion has a first side on which the curved edge is formed and a second side on which the neck portion is formed. The first side is opposite to the second side or adjacent to the second side.

The connecting portion, the neck portion and the cutting portion are integrally formed.

### BRIEF DESCRIPTION OF DRAWINGS

The invention can be more fully understood by reading the subsequent detailed description and examples with references made to the accompanying drawings, wherein:

FIG. 1 is a schematic view of a dissecting device of the invention;

FIG. 2a is a schematic view of an embodiment of a blade of the invention;

FIG. 2b is a free body diagram of a cutting portion of the blade of FIG. 2a;

FIG. 3 is a schematic view of another embodiment of a blade of the invention;

FIG. 4 is a schematic view of another embodiment of a blade of the invention;

FIG. 5 is a schematic view of another embodiment of a blade of the invention; and

FIG. 6 depicts the relationship between the displacement of the blade and the contact points.

### DETAILED DESCRIPTION OF INVENTION

The invention discloses a dissecting device with a curved blade having an elastic structure. When the blade cuts an organism on a table, the elastic structure bends to rotate the blade. The curved blade has rolling contact with the table due to the rotation of the blade and the horizontal movement of the table. As rolling contact only occurs between the curved blade and the table, the blade cuts, rather than tears the organisms into cell pieces which have a complete shape. The structure of the dissecting device is described as follows.

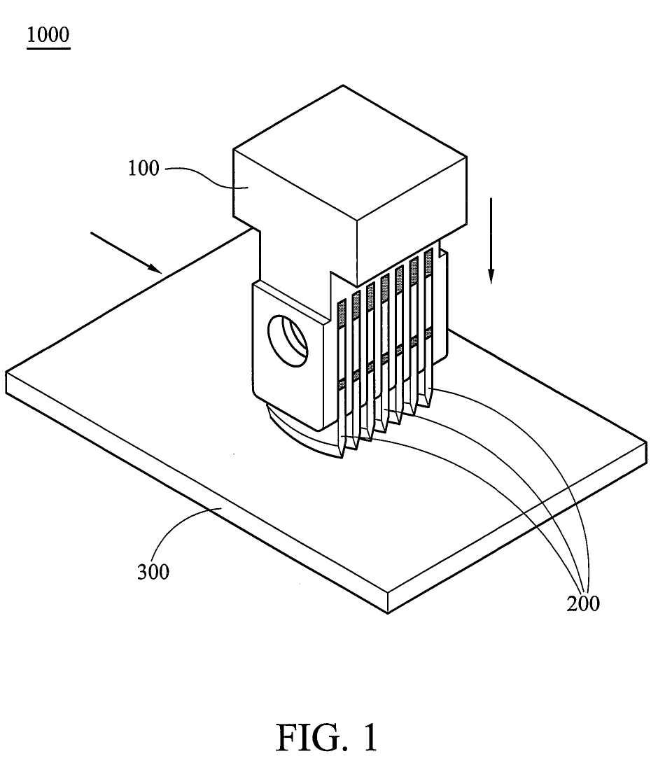

Referring to FIG. 1, the dissecting device 1000 comprises a base 100, a plurality of blades 200 and a table 300. The blades 200 are installed on the base 100. An organism to be dissected is placed on the table 300. The base 100 and the blades 200 are disposed above the table 300 and able to lower and raise to respectively approach or depart from the horizontally movable table 300.

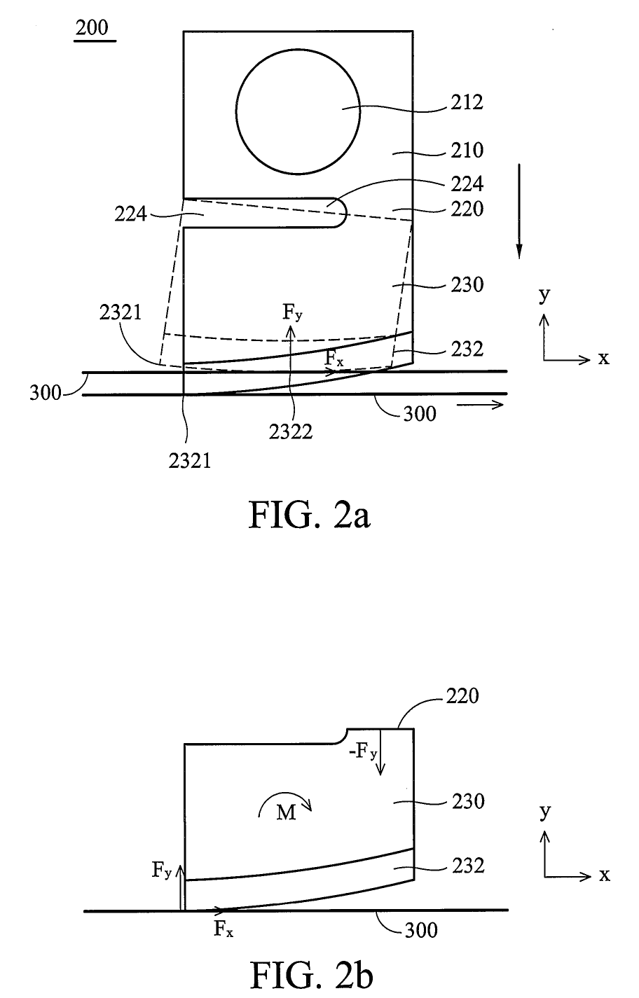

Referring to FIG. 2a, the blade 200 comprises a connecting portion 210, a neck portion 220 and a cutting portion 230. The neck portion 220 connects the connecting portion 210 and the cutting portion 230. The connecting portion 210 has a through hole 212 with which the base 100 is engaged. The cutting portion 230 has a curved edge 232. Because the size of the neck portion 220 is much smaller than the connecting portion 210 and the cutting portion 230, a gap 224 is formed between the connecting portion 210 and the cutting portion 230. When the blade 200 descends with the base 100 to contact the table 300, the cutting portion 230 is pushed by the normal force of the table 300 to rotate with respect to the neck portion 220. The curved edge 232 contacts the table 300 at a first point 2321. The blade 200 continuously descends until the cutting portion 230 completely cuts off the organism. At this time, the edge 232 contacts the table 300 at a second point 2322. The directions of the normal force on every point between the first point 2321 and the second point 2322 do not pass through the neck portion 220. In other words, lines formed by every point between the first point 2321 and the second point 2322 to the neck portion 220 are not parallel to the descending direction of the blade 200. A clockwise torque is exerted on the cutting portion 230, which rotates the cutting portion 230 to cut off the organism on the table 300. When the organism is cut off, the curved edge 232 contacts the table 300. At the first points 2321, the table 300 exerts a horizontal force Fx and a normal force Fy on the edge 232. The horizontal force Fx moves the edge 232 in x direction to slide on the table 300. The table 300 must therefore move in the x direction to compensate for the sliding of the edge 232, which enables the edge 232 to maintain rolling contact with the table 300 without tearing the organism. The table 300 moves at a speed proportional to the descending speed of the blade 200.

FIG. 2b is a free body diagram of the edge 232. A force exerted by the base 100 to the connecting portion 210 is transferred to the cutting portion 230 via the neck portion 220. The force −Fy exerted by the base 100 has the same magnitude but the opposite direction of the force Fy exerted by the table 300 and does not align with the force Fy, thus, a moment M is generated by the forces Fy and −Fy to rotate the cutting portion 230 with respect to the neck portion 220. Only when the lines formed by the contact points of the edge 232 and the table 300 to the neck portion 220 are not parallel to the descending direction of the cutting portion 230, the forces Fy and −Fy have the same magnitude and the opposite directions without alignment, whereby a moment is generated to rotate the cutting portion 230.

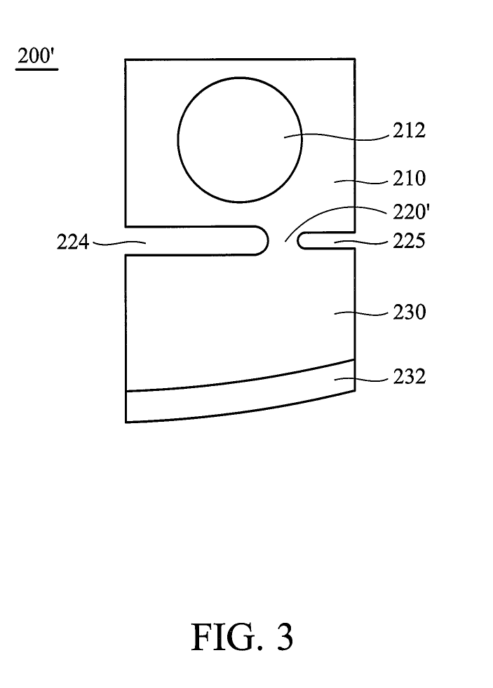

FIG. 3 depicts another embodiment of the blade. The blade 200′ comprises a connecting portion 210, a neck portion 220′ and a cutting portion 230. The blade 200′ has two gaps 224 and 225 on both sides of the neck portion 220′. Other elements of the embodiment of FIG. 3 are the same as the embodiment of FIG. 2a, thus, further description thereof is omitted for brevity. In FIG. 3, the neck portion 220′ is less rigid than the neck portion 220 in FIG. 2a, thus, less force is required to rotate the cutting portion 230.

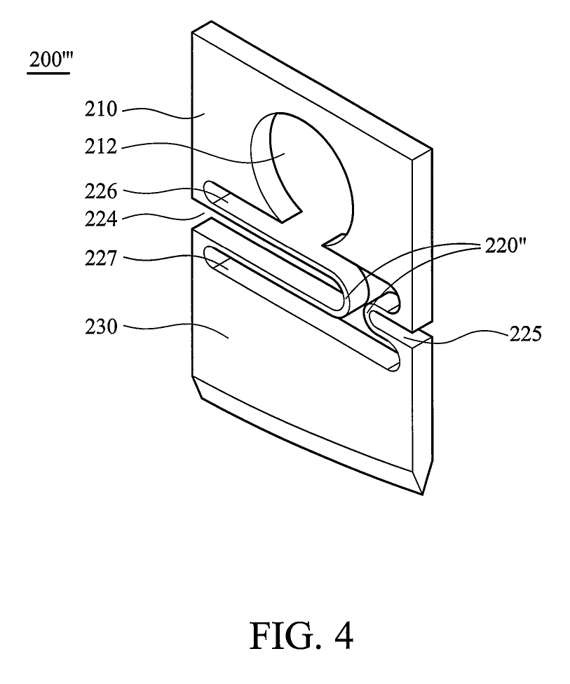

FIG. 4 depicts another embodiment of the blade of the invention. A blade 200′″ comprises a connecting portion 210, a neck portion 220′″ and a cutting portion 230. The neck portion 220′″ is formed by wire cutting. The neck portion 220′″ can be formed when a through hole 212 is formed. The neck portion 220′″ is hollow. Two grooves 226 and 227 are formed on both sides of the gaps 224 and 225. The grooves 226 and 227 are connected to the neck portion 220′″. The described structure may increase elasticity of the neck portion 220′″.

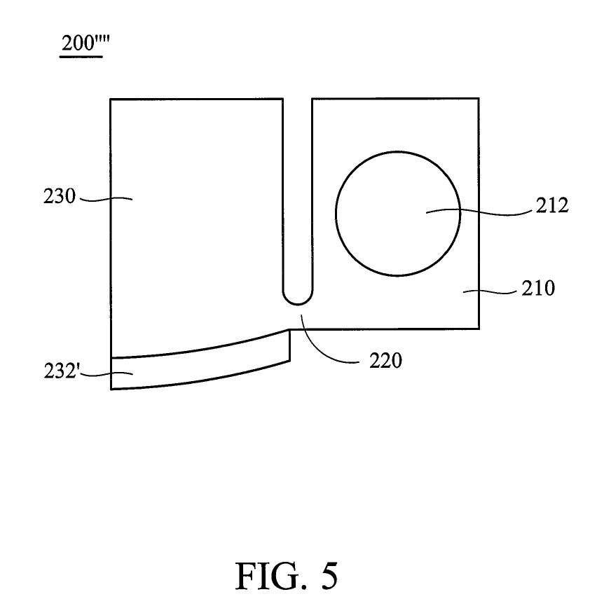

FIG. 5 depicts another embodiment of the blade of the invention. A blade 220′″ comprises a connecting portion 210, a neck portion 220 and a cutting portion 230 having a curved edge 232′. Compared with the embodiment of FIG. 2a, the neck portion 220 is connected to one side of the cutting portion 230, and the curved edge 232 is formed on opposite side of the cutting portion 230. In this embodiment, the side of curved edge 232′ is adjacent to the side connected to the neck portion 220.

In general, the blade has a thickness of 0.05˜1 mm. In the described embodiments, the blade has a thickness of 0.4 mm.

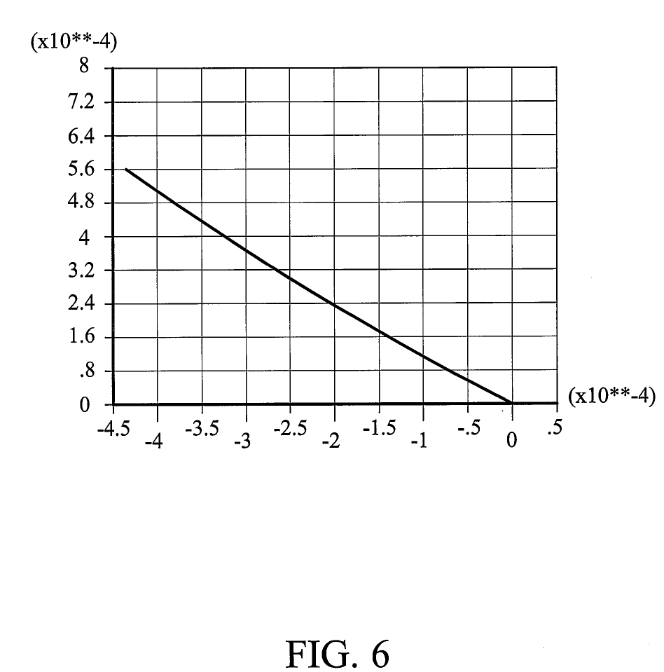

The described elastic structure allows the blade to bend and rotate, when descended for cutting an organism. When the blade descends and the table is fixed, the blade slides on the table, as shown in FIG. 6, wherein the X-axis represents the descended distance, and the Y-axis represents the point of the blade contacting the table. To maintain the rolling contact between the blade and the table, the table must be moved relative to the descended distance of the blade.

The blade cuts the organism by rolling over the organism without sliding, thus, the blade does not tear the organism. Cells or tissues cut from the organism can retain their shape without affecting biological conditions.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A dissecting device for dissecting cells and tissues of an organism, comprising:
a table bearing an organism; and
at least one blade lifted or lowered to approach or depart from the table comprising:
a connecting portion, a cutting portion having a curved edge, and a neck portion connecting the connecting portion and the cutting portion, wherein when the blade is lowered to contact the table, the cutting portion is rotated with respect to the neck portion to have rolling contact with the table from a first point to a second point of the edge.

2. The dissecting device as claimed in claim 1, wherein lines formed by connecting every point on the edge between the first point and the second point to the neck portion are not parallel to a moving direction of the blade when the blade is lowered.

3. The dissecting device as claimed in claim 1 further comprising a base lifted or lowered to approach the table; the connecting portion further comprising a through hole with which the base is engaged, whereby the base is connected to the connecting portion.

4. The dissecting device as claimed in claim 1, wherein when the blade is lowered to contact the table, the table moves in a first direction substantially parallel to a line formed by the first and second points to maintain the rolling contact between the blade and the table.

5. The dissecting device as claimed in claim 1, wherein at least one gap formed on one side of the neck portion is between the connecting portion and the blade and.

6. The dissecting device as claimed in claim 5, wherein the connecting portion has a first groove near the gap, and the cutting portion has a second groove near the gap.

7. The dissecting device as claimed in claim 1, wherein two gaps formed on both sides of the neck portion are between the connecting portion and the blade and.

8. The dissecting device as claimed in claim 1, wherein the cutting portion has a first side on which the curved edge is formed and a second side on which the neck portion is formed.

9. The dissecting device as claimed in claim 8, wherein the first side is opposite to the second side.

10. The dissecting device as claimed in claim 8, wherein the first side is adjacent to the second side.

11. The dissecting device as claimed in claim 1, wherein the connecting portion, the neck portion and the cutting portion are integrally formed.

12. The dissecting device as claimed in claim 1, wherein the material of the cutting portion comprises metal, alloy, glass or ceramic.

13. The dissecting device as claimed in claim 1, wherein the material of the neck portion comprises metal, alloy, glass or ceramic.

14. The dissecting device as claimed in claim 1, wherein the thickness of the blade is 0.05 mm to 1 mm.

15. A blade comprising:
a cutting portion having a curved edge to cut a organism on a table; and
a neck portion connected to the cutting portion, wherein when the blade is lowered to contact the table and cut the organism, the cutting portion is rotated with respect to the neck portion to have rolling contact with the table from a first point to a second point of the edge.

16. The blade as claimed in claim 15, wherein lines formed by connecting every point on the edge between the first point and the second point to the neck portion are not parallel to a moving direction of the blade when the blade is lowered.

17. The blade as claimed in claim 15, wherein when the blade is lowered to contact the table, the table moves in a first direction substantially parallel to a line formed by the first and second points to maintain the rolling contact between the blade and the table.

18. The blade as claimed in claim 15 further comprising a connecting portion connected to the cutting portion by the neck portion to formed at least one gap between the connecting portion and the cutting portion on one side of the neck portion.

19. The blade as claimed in claim 18, wherein the connecting portion has a first groove near the gap, and the cutting portion has a second groove near the gap.

20. The blade as claimed in claim 15 further comprising a connecting portion connected to the cutting portion by the neck portion to formed at least one gap between the connecting portion and the cutting portion on both sides of the neck portion.

21. The blade as claimed in claim 15, wherein the cutting portion has a first side on which the curved edge is formed and a second side on which the neck portion is formed.

22. The blade as claimed in claim 21, wherein the first side is opposite to the second side.

23. The blade as claimed in claim 21, the first side is adjacent to the second side.

24. The blade as claimed in claim 15, wherein the neck portion and the cutting portion are integrally formed.

25. The blade as claimed in claim 15, wherein the material of the cutting portion comprises metal, alloy, glass or ceramic.

26. The blade as claimed in claim 15, wherein the material of the neck portion comprises metal, alloy, glass or ceramic.

27. The blade as claimed in claim 15, wherein the thickness of the blade is 0.05 mm to 1 mm.

28. A dissecting method of dissecting cells and tissues of an organism, comprising the following steps:
providing a curved blade;
placing the organism on a table;
lowering down the curved blade to contact the table; and
moving the table horizontally to maintain rolling contact between the curved blade and the table.

29. The dissecting method as claimed in claim 28 further comprising the following steps:
providing a base to which the curved blade is connected and rotated with respect to the base; and
lowering down the base to enable the curved blade to contact the table and rotate with respect to the base.
